(19) United States
(12) Patent Application Publication
(10) Pub. No.: US 2013/0112049 A1
(43) Pub. Date: May 9, 2013

(54) Torque Tool Cycle Counter

(71) Applicant: Christopher Lawton, Costa Mesa, CA (US)

(72) Inventor: Christopher Lawton, Costa Mesa, CA (US)

(21) Appl. No.: 13/289,708

(22) Filed: Nov. 4, 2011

(51) Int. Cl. B25B 23/142; B25B 23/00

(52) U.S. Cl. 81/429; 81/467

(57) ABSTRACT

A tool for applying torque to workpieces, having a sensor adapted to detect a rotational parameter measured during application of torque to each of the workpieces, wherein the rotational parameter includes an amount of angular rotation applied to each of the workpieces an/or an amount of torque applied to each of the workpieces, a memory operably coupled to the sensor and including a stored number of cycles, wherein the sensor is adapted to add a cycle count to the stored number of cycles each time that the rotational parameter meets a parameter threshold to indicate a number of the workpieces in which the rotational parameter meets the parameter threshold, and an indicator adapted to indicate to a user when the parameter threshold has been met for one of the workpieces and to indicate the stored number of cycles.

### TECHNICAL FIELD OF THE INVENTION

The present application relates generally to tools that apply torque to a workpiece. More particularly, the present application relates to a cycle counter for a torque application tool that measures the amount of rotations and torque cycles applied to workpieces by the tool.

### BACKGROUND OF THE INVENTION

Wrenches, pliers and ratchets are well known tools adapted to apply torque to a workpiece, such as a bolt, nut or screw, and drive the workpiece into a working material. These tools typically have a handle on one end and an engagement portion on another end that fittingly engages the workpiece. Rotating the tool in a rotational direction (typically clockwise) imparts rotational force to the workpiece, causing the workpiece to be driven into the working material, while rotating the tool in the opposite rotational direction (typically counterclockwise) drives the workpiece in the opposite rotational direction and out of the working material.

A typical torque application requires several “cycles” of rotational movement until the workpiece is sufficiently driven into the working material. For example, a user may rotate the tool several times in order to drive the workpiece into the working material to a desired torque amount. The number of required cycles is also dependent on the angle of rotation per cycle, and whether any slip occurs when the user rotates the ratchet. As a result, a number of variables factor in to the torque operation and cause inconsistent torque amounts to be applied to different workpieces in the same device.

Moreover, many torque application operations require the user to apply torque to several workpieces in a specified process or sequence. For example, a technician may be required to torque ten bolts of an engine head at 20 ft-lb increments of torque per bolt. If one of the ten bolts is rotated at more than 20 ft-lb of torque, that bolt could be temporarily “over-torqued”, relative to the other bolts, and may compromise the structural integrity of the adjacent bolts as well as the engine head. Moreover, it is important to ensure that each of the ten bolts are sufficiently and properly torqued to the proper specifications.

### SUMMARY OF THE INVENTION

The present application discloses a system, method and apparatus for measuring torque operation parameters and using the measured parameters to verify completion of a specific torque application process. In an embodiment, the tool of the present application includes a torque cycle counter and an angle cycle counter to measure the number of cycles that a predetermined amount of torque and/or rotational angle, respectively, is applied to workpieces. The tool can record the specific torque operation performed by the user and store data indicative of the torque operation in a memory of the tool. As a result, the tool can verify whether each of a plurality of workpieces is properly torqued according to a predetermined process for rotating the workpieces. The workpieces can therefore be rotated with a substantially equal amount of torque or angular rotation, incrementally, and in an order specified by the process.

The present application also discloses a tool adapted to rotate a workpiece in a torque operation, wherein the tool includes a sensor adapted to detect a rotational parameter measured during the torque operation; a memory operably coupled to the sensor; and a processor adapted to determine whether the rotational parameter meets a predetermined parameter threshold.

In addition, the present application discloses a non-transitory computer readable medium operably coupled with a processor and adapted to store computer program instructions that cause the processor to detect a rotational parameter measured during a torque operation of a tool; determine whether the rotational parameter meets a predetermined parameter threshold; and store the number of cycles.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of a tool incorporating the cycle counter of the present application;

FIG. 2 is a schematic diagram of electrical components disposed in the tool illustrated in FIG. 1;

FIG. 3 is a schematic diagram of a sensor disposed in the tool illustrated in FIG. 1; and

FIG. 4 is a flowchart detailing a method of operating a tool of the present application.

It should be understood that the comments included in the notes as well as the materials, dimensions and tolerances discussed therein are simply proposals such that one skilled in the art would be able to modify the proposals within the scope of the present application.

### DETAILED DESCRIPTION OF THE EMBODIMENTS

While the present invention is susceptible of embodiments in many different forms, there is shown in the drawings, and will herein be described in detail, a preferred embodiment of the invention with the understanding that the present disclosure is to be considered as an exemplification of the principles of the invention and is not intended to limit the broad aspect of the invention to embodiments illustrated.

The present application discloses a system, method, and apparatus for counting a parameter, such as the number of rotational cycles applied by a tool or the number of torque applications of the tool, and using the measured parameters to verify completion of a specific torque application process. The tool can include a torque cycle counter or an angle cycle counter, or both, to measure the number of times that the torque and rotational angle, respectively, achieve a predetermined threshold. The tool can record the specific torque operation performed by the user and store data indicative of the number of successful torque cycles in a memory of the tool. The stored values can be retrieved by a user to determine whether workpieces have been subjected to the correct torque process. In an embodiment, the tool is a torque wrench.

The purpose of the present invention ensures that a plurality of workpieces each properly receives the appropriate amount of torque when sequentially driven into a working material. For example, a back panel of a television requires several screws to be assembled in order to correctly fasten the back panel to the television while minimizing the risk of warping the back panel. A technician can damage both the screw and the back panel if the technician applies a disproportionate amount of torque to one of the screws before the other screws have an appropriate amount of torque or angular rotation applied. However, the present invention counts the number of cycles in which a predetermined amount of torque and/or angular rotation was applied to a workpieces, allowing the technician to determine whether each of the workpieces was appropriately torqued or whether a disproportionate amount of torque was applied to one or more of the workpieces. For example, the screw may require to be sequentially driven at 20 ft-lb increments, or alternately 180° angular rotations, to achieve the final desired torque of 100 ft-lb per screw. Failure to sequentially torque the screws in such a manner may cause the back panel to warp. By using the torque application cycle count and/or angular rotation cycle count of the present application, the technician can ensure that each of the screws was properly driven.

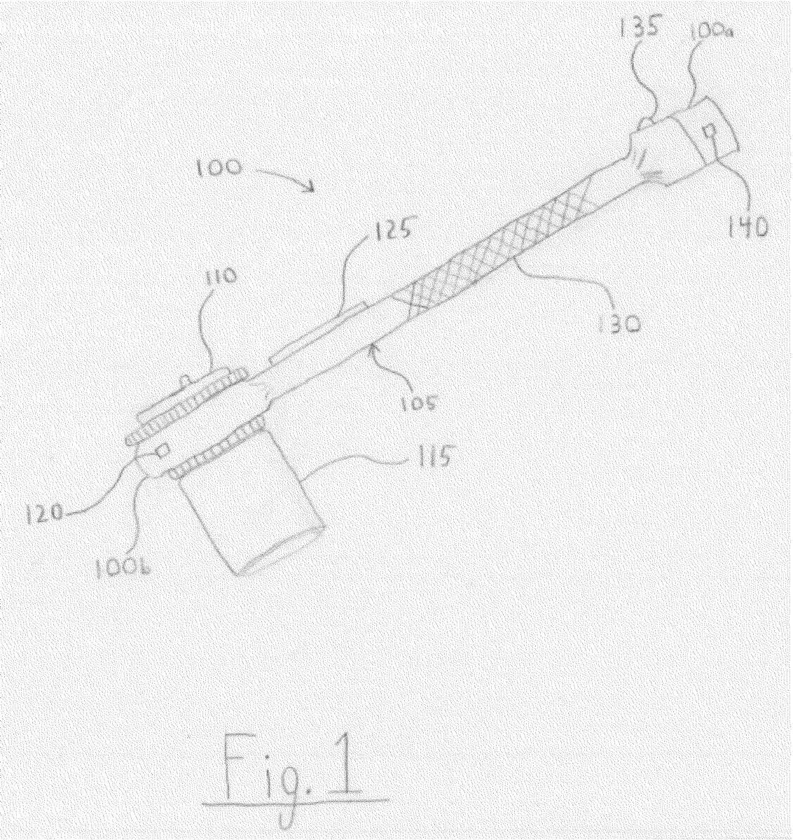

As shown in FIG. 1, the present application discloses a tool 100 (shown as a torque wrench) having a first end 100a and a second end 100b, and a handle 105 adjacent the second end 100b. A selection lever 110 is provided near the second end 100b to operate the ratchet mechanism and chose which rotational direction applies torque to a workpiece in a well-known manner. Removably coupled to the second end 100b is an engagement 115, such as a socket or a bit, adapted to engage a workpiece and transmit torque to the workpiece when a user rotates the tool 100. A sensor 120 may be provided near engagement 115 that is adapted to sense the amount of torque applied to the workpiece and/or the angular rotation at which the engagement 115 is rotated during each cycle of applying torque to a workpiece. The tool 100 may also include an interface 125 adapted to receive user input or display information to the user, and a grip 130 that allows the user to grasp the tool 100 during use. The tool 100 can include an indicator 135 adjacent to the first end 100a to notify the user when a particular torque condition has been met, and a transceiver 140 to transmit data to and receive data from a remote computer. In an embodiment, the indicator 135 could be an LED, or it could be incorporated internal to the tool 100 to provide tactile or audible feedback.

As shown, tool 100 is a torque ratcheting wrench with a hexagonal socket attached. However, the tool 100 can be any tool adapted to apply torque to a workpiece. For example, the tool 100 can be a wrench, pliers, screwdriver, or any other hand tool. Additionally, the tool 100 can be a power tool adapted to apply torque, such as an electronic or air-powered drill.

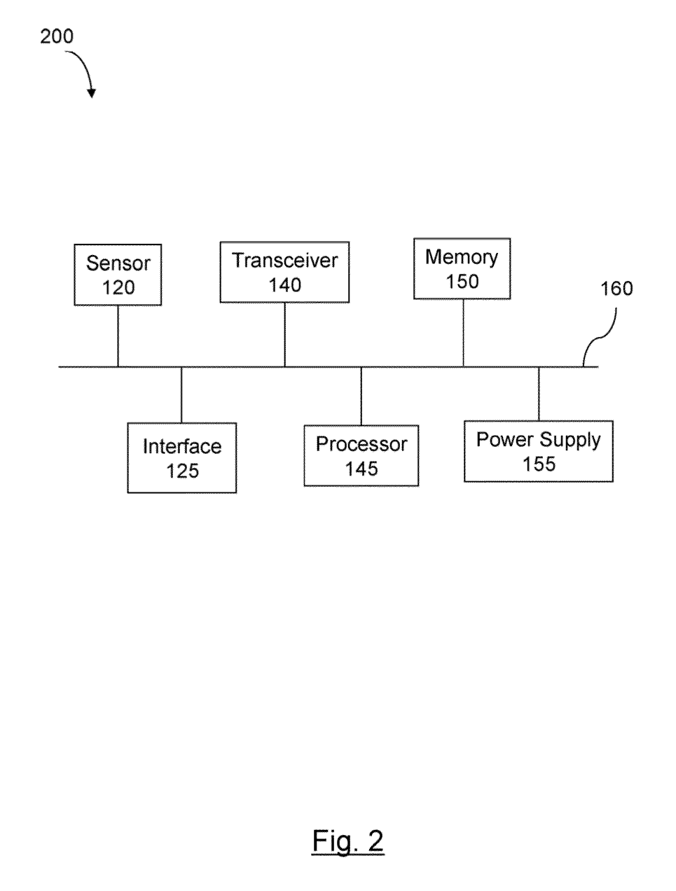

As shown in FIG. 2, the tool 100 can include an electrical component 200 including a sensor 120, interface 125, and transceiver 140 discussed above, and further including a processor 145, memory 150, and power supply 155, each operably coupled to one another by a bus 160. The electrical component 200 may be adapted to supply power to the tool 100, if necessary, and run necessary software and/or firmware to function the tool 100.

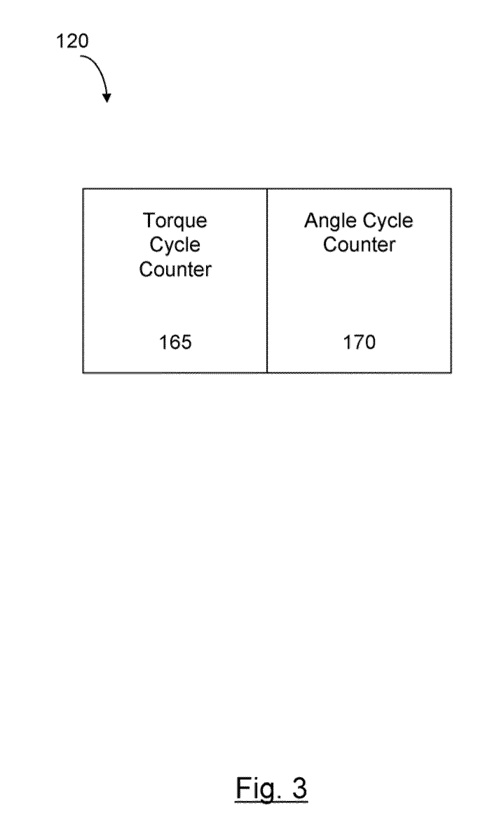

As shown in FIG. 3, the sensor 120 is adapted to facilitate a torque cycle counter 165 and an angle cycle counter 170 to sense when the rotation of the tool 100 has applied a threshold amount of torque or a threshold angular rotation, respectively, to workpieces. In operation, the torque and rotational amounts are measured using sensor 120 and then compared against a threshold value stored in the memory 150. If the torque amount and/or angular rotation amount meets the threshold value, the application of torque or the rotational amount of the tool 100 will qualify as a torque cycle or an angle cycle, respectively. Once a torque cycle or angle cycle is determined, the program may add a one “count” to the existing number of torque and/or angle cycles stored in memory.

In an embodiment, the present invention can help technicians verify that a particular torque operation was properly applied to a plurality of workpieces that are to be sequentially tightened using a specified torque application process. For example, the desired torque operation may require the technician to tighten each of 10 bolts at 20 ft-lb or 180° rotational incremental torque applications. The user can repeatedly rotate the tool 100 to apply torque to a first workpiece, as with a conventional ratchet set, and when the application of torque reaches the threshold torque value of 20 ft-lb and/or 180° rotational angle, the program stored in the memory 150 reflects that one cycle has been achieved, and thus one workpiece has been properly rotated. When the technician applies torque to a subsequent workpiece, the sensor 120 again senses the applied torque and/or rotational angle and, if the applied torque or rotational angle meets a predetermined threshold, the program will add an additional one torque cycle count to the stored number of torque cycle counts to indicate the number of workpieces that have been properly tightened.

Once the above process is performed, the technician can review the information stored in the memory and determine whether the correct torque operation was performed to each of the workpieces. Using the example above, if the retrieved data reflects 10 cycles were completed (indicating 10 successful torque applications), the technician can assume that all 10 of the bolts were properly tightened. However, if the data only reflects 8 cycles were completed, the technician knows that 2 of the workpieces are not properly tightened and may require an additional torque operation. In an embodiment, the memory 150 can then be reset at the end of the torque operation, so that the torque cycle counter and rotational angle counter are reset to zero. The present application thus provides a useful system for verifying that similarly situated workpieces are subjected to a similar torque application operation and are uniformly tightened to a specified torque amount and/or angular rotation amount.

The interface 125 is adapted to allow the user to enter a torque operation and to view prior torque applications performed by the tool 100. For example, the interface 125 can be a touch screen, keyboard, display, or any other interface 125 that allows the user to input variables such as the required torque threshold, angle threshold, torque cycles, and angle cycles for the torque operation.

In an embodiment, the interface 125 allows the user to reset the cycle counter to zero prior to conducting the torque operation on a different plurality of workpieces. Alternately, the instruction to reset the cycle counter can be transmitted from a remote computer or device and to the transceiver 140. Any other manner of resetting the cycle counter can be implemented without departing from the spirit and scope of the present application.

The resetting operation is advantageous because it provides the user the ability to apply a first torque operation on a set of workpieces (e.g., a first application of 40 ft-lb of torque to a plurality of bolts for an engine head), wherein the cycles can be reset upon completion, and then apply a second torque operation to the workpieces (e.g., a second application of 80 ft-lb of torque to the same plurality of bolts for an engine head). By using the cycle counter for the first torque operation, the user can verify that each of the plurality of bolts received the correct amount of torque and/or angular rotation required during the first operation by comparing the cycle counter to the number of bolts (e.g., if there are 10 completed cycles, and 10 bolts, it can be assumed that each of the 10 bolts received the correct torque application). Then, by resetting the cycle counter after the first operation, the user can verify that each of the plurality of bolts received the correct amount of torque and/or angular rotation required during the second operation. The user-resettable functionality of the tool 100 allows the user to reset the cycle counter to zero after completion of the torqueing operation and verification that the number of completed torque cycles matches the number of workpieces to be tightened.

The user can also input appropriate tolerances to the threshold torque and rotational angular values through interface 125. For example, the user can choose an appropriate threshold value for counting as a complete cycle even if the applied torque amount is 95% of the predetermined threshold torque value. By default, the tool 100 will count a cycle if the applied torque amount and/or rotational angle is within approximately 98%-110% of the threshold parameter torque or angle. In an embodiment, upon reaching 110% of the threshold amount, the tool 100 can cause the pawl mechanism to disengage from the gear assembly to prevent further torque from being applied to the workpiece to avoid “over-torqueing” the workpiece.

As discussed above, an interface 125 can be used to receive user input relating to the torque operation. However, these parameters need not be input by the user and can be transmitted from a remote computer and received by the transceiver 140. The tool 110 can also be disabled from changing torque operation parameters via the interface 125 based on instructions received by the transceiver 140. Following the torque operation, the data stored in the memory 150 relating to the torque operation can be transmitted to the remote computer with or without indication to the user that such information is transmitted.

The indicator 135 can be used to notify the user when the tool 100 reached the desired torque threshold parameter and/or angle threshold parameter to qualify as a cycle count. For example, the indicator 135 can be a light, a tactile mechanism, or audible feedback to notify the user when a cycle is complete. In an embodiment, the indicator 135 may include two lights (e.g., one red and one green) to indicate when the rotational angle amount is complete (e.g., the red light) and when the torque amount is complete (e.g., the green light). Any other form of providing a cycle indication to the user can be used without departing from the spirit and scope of the present application.

The memory 150 can store information relating to the tool 100, such as torque parameters, measured torque values, torque cycles, angle cycles, and any other information relevant to the torque operation. By way of example, and not limitation, the memory 150 can be a non-transitory computer-readable recording medium. As used throughout this application, the term “non-transitory computer-readable recording medium” excludes only signals and carrier waves, per se, and is not meant to exclude other types of memory that may be considered “transitory” such as RAM or other forms of volatile memory.

The power supply 155 supplies electrical power to the tool 100 from either an independent or dependent source. In an embodiment, the power supply 155 is a battery. However, the power supply 155 can be any component that supplies power, including a battery, fuel cell, engine, solar power system, wind power system, hydroelectric power system, a power cord for attachment to an electrical socket, or any other means of providing power.

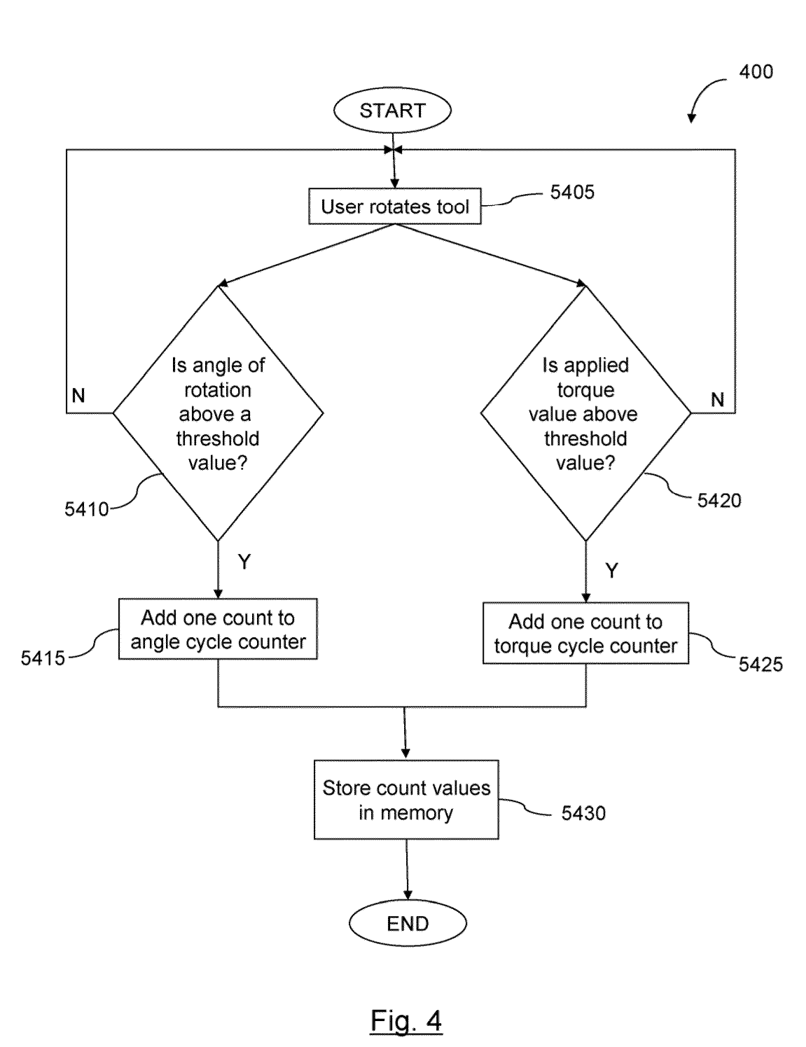

FIG. 4 illustrates a flow chart detailing a process according to the present application. As shown, the process 400 begins and proceeds to step S405, where the user rotates the tool and applies torque to a workpiece. Following step S405, the tool 100 determines whether an angle cycle and/or a torque cycle occurred and updates the torque and angle cycle count in the memory 150 if such a cycle occurred. For example, the process 400 can proceed to step S410 when the system determines whether the angle of rotation meets a threshold parameter value. If the applied angle meets the threshold parameter value, the process 400 proceeds to step S415 where a count is added to the angle cycle counter. Alternately, if the applied angle is less than the threshold value, the process reverts back to before step S405 and begins again. A similar operation can be applied to the torque value received from the sensor—the process 400 can determine whether the applied torque value is above a threshold parameter value S420, and if so, add one count to the torque cycle counter S425. If the torque value is below the threshold parameter value, the process can revert back to before S405 and begin again. Once the angle and torque cycle values are added to the existing cycle values, the process proceeds to step S430 where such information is stored in the memory 150. Following step S430, the process ends and a user can retrieve the information and/or have the information transmitted via the transceiver 140.

It should be noted that, between each application of the above process, the user can reset the counter cycles after completion of a torqueing operation and before beginning a different torque operation. In an embodiment, the user can operate on a first set of workpieces (e.g., bolts for an engine head) under a first torque operation (with user-input torque thresholds and/or angle thresholds) to ensure that the correct number of torque cycles has been reached, and can then reset the cycle counter before performing a second torque operation on a second set of workpieces (e.g., screws for a back panel of a television).

The above process can be applied to each of a plurality of workpieces that are sequentially tightened according to a specified tightening protocol. Each time a workpiece is appropriately tightened, a cycle is added to the cycle count to indicate the number of workpieces appropriately tightened. The user can then verify whether the specified tightening protocol was performed if the number of cycles corresponds to the number of workpieces.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A tool adapted to apply torque to workpieces, comprising:
a sensor adapted to detect a rotational parameter measured during a torque application operation applied to each of the workpieces;
a memory operably coupled to the sensor;
a processor adapted to determine whether the rotational parameter meets a parameter threshold and, if the processor determines that the rotational parameter meets the parameter threshold, the processor adds a cycle count to a stored number of cycles to indicate a number of the workpieces in which the rotational parameter meets the parameter threshold, and stores the number of cycles in the memory; and
an interface adapted to receive an instruction to reset the stored number of cycles after the torque application operation is applied to all of the workpieces.

2. The tool of claim 1, wherein the rotational parameter is an amount of torque applied to each of the workpieces.

3. The tool of claim 1, wherein the rotational parameter is an amount of angular rotation that the tool caused to be applied to each of the workpieces.

4. The tool of claim 1, wherein the rotational parameter is an amount of angular rotation that the tool caused to be applied to each of the workpieces and an amount of torque applied to each of the workpieces.

5. The tool of claim 1, further comprising an indicator adapted to provide an indication to a user that the parameter threshold has been met.

6. The tool of claim 5, wherein the indicator is selected from the group including a light, a tactile mechanism, and an audible mechanism.

7. The tool of claim 1, wherein the interface is adapted to receive the parameter threshold.

8. The tool of claim 1, wherein the processor adds the cycle count to the stored number of cycles when the rotational parameter is within about 98% to about 110% of the parameter threshold.

9. The tool of claim 1, wherein the interface is adapted to display the parameter threshold and the stored number of cycles.

10. The tool of claim 1, further comprising a transceiver operably coupled to the tool and adapted to transmit data indicating the number of cycles to a remote computer.

11. A tool for sequentially applying torque to a plurality of workpieces, comprising:
an engagement adapted to engage and transmit torque to each of the workpieces;
a sensor adapted to detect a rotational parameter measured during application of torque to each of the workpieces;
a memory operably coupled to the sensor, wherein the sensor is adapted to convey to the memory a cycle count to a stored number of cycles to indicate a number of the workpieces in which the rotational parameter meets the parameter threshold; and
an interface adapted to receive input to reset the cycle count to zero after the stored number of cycles matches the number of workpieces.

12. The tool as claimed in claim 11, wherein the rotational parameter includes an amount of angular rotation applied to each of the workpieces.

13. The tool as claimed in claim 11, wherein the rotational parameter includes an amount of torque applied to each of the workpieces.

14. The tool as claimed in claim 11, wherein the rotational parameter includes an amount of angular rotation applied to each of the workpieces and an amount of torque applied to each of the workpieces.

15. A torque wrench for applying torque to a plurality of workpieces, comprising:
an engagement adapted to engage and transmit torque to each of the workpieces;
a sensor adapted to detect a rotational parameter measured during application of torque to each of the workpieces, wherein the rotational parameter includes an amount of angular rotation applied to each of the workpieces and an amount of torque applied to each of the workpieces;
a memory operably coupled to the sensor and including a stored number of cycles, wherein the sensor is adapted to add a cycle count to the stored number of cycles each time that the rotational parameter meets a parameter threshold to indicate a number of the workpieces in which the rotational parameter meets the parameter threshold; and
an indicator adapted to indicate to a user when the parameter threshold has been met for one of the workpieces and the stored number of cycles,
wherein the stored number of cycles is adapted to be reset after torque is properly applied to all of the workpieces.

16. The torque wrench of claim 15, wherein the sensor adds the cycle count to the stored number of cycles when the rotational parameter is within about 98% to about 110% of the parameter threshold.
